(19) United States
(12) Patent Application Publication
(10) Pub. No.: US 2009/0064868 A1
(43) Pub. Date: Mar. 12, 2009

(54) Pressure Cooker Lid

(75) Inventor: Andrea Cartossi, Verbania Fondotoce (IT)

Correspondence Address: LADAS & PARRY, 5670 WILSHIRE BOULEVARD, SUITE 2100, LOS ANGELES, CA, 90036-5679, US

(73) Assignee: INOXIA S.R.L., Domodossola (VB) (IT)

(21) Appl. No.: 11/791,046

(22) PCT Filed: Nov. 29, 2005
(86) PCT No.: PCT/EP05/56314

§ 371 Date: Feb. 27, 2008

(30) Foreign Application Priority Data
Dec. 6, 2004 (IT) MI2004 A 002344

(51) Int. Cl. A47J 27/08

(52) U.S. Cl. 99/337; 220/324; 220/912

(57) ABSTRACT

The pressure cooker lid (10; 10A), comprises: a support element (12) which, in the manner of a lid, fits onto the outwardly extending upper edge of a cooking receptacle; a plurality of jaws (16) to engage the outwardly extending edge of the receptacle; a mechanism (20; 20A) comprising a coaxial rotatable element (22; 22A), the mechanism enabling the jaws (16) to be controlled by rotating the rotatable element (22; 22A); a handgrip connected directly or indirectly to the support element (12), for manipulating the lid (10; 10A); an operating means (30; 30A) for rotating the rotatable element (22; 22A), comprising a knob (35; 35A) for operation by the user. The movement of the rotatable element (22; 22A) by the action of the operating means (30; 30A) is independent of the handgrip (34), the rotatable element (22; 22A) being free to move relative to the handgrip (34).

The present invention relates to pressure cooker lids.

A known pressure cooker lid comprises a support element which, in the manner of a lid, fits onto the outwardly extending upper edge of a cooking receptacle by way of an interposed seal gasket; and a plurality of movable jaws carried by the support element, the end portions of which are intended to engage the outwardly extending upper edge of the cooking receptacle. Said support element also carries a mechanism comprising an element rotatable about the axis of the support element, this mechanism enabling the jaws to be made to approach or respectively withdraw from the support element (by rotating the rotatable element in one direction or the other), to cause the end portions of the jaws to engage the outwardly extending edge of the cooking receptacle (in such a manner as to grip under the outwardly extending edge) and respectively to disengage said end portions from said edge.

An operating means is also provided for rotating said rotatable element, to consequently cause the jaws to withdraw from the outwardly extending edge of the receptacle (in order to be able to remove the lid), or to approach said edge in order to apply the lid to the receptacle. In all pressure cooker lids having the aforedescribed characteristics, which have been known for three decades and are widely available commercially, the operating means for rotating the rotatable element is situated above the rotatable element itself, coaxially to this latter and hence to the lid. It follows that for each movement of the operating means by the user there is a corresponding rotary coaxial movement (in one direction or the other) of the underlying rotatable element. In view of the central position of the operating means, this latter also acts as the handgrip for the lid, enabling it to be manipulated.

The aforedescribed known lids present various drawbacks, which will now be described.

When such a lid is used, the user must, with one and the same hand, grip the lid handgrip (which coincides with the operating means); position the lid on the cooking receptacle; exert on the handgrip a not inconsiderable pressure to prevent the support element from slipping (dragged by the rotary movement of the operating means) on the outwardly extending edge of the cooking receptacle; and finally impress on the operating means (coinciding with the manipulating handgrip) a rotary movement enabling the rotatable element to rotate through an angle sufficient to cause the ends of the jaws to approach the outwardly extending edge of the receptacle until they engage below it.

As will be apparent, this is an operation which, besides not being easy (seeing that two different movements, that is pressing and rotating, have to be performed simultaneously with one and the same hand), also requires a not inconsiderable force.

As the users of pressure cookers are mainly women, a means of making the aforedescribed operation less difficult would certainly be welcome. For example, this would be very useful in the case of persons who because of various problems (for example illness, trauma, handicap or advanced age) are unable to exert with a single hand a rotation action on the operating means together with a simultaneous significant thrust action.

It must also be added that the user's difficulties increase when the reverse operation is required, that is removing the lid from the cooking receptacle. This operation, which also requires the operating means (coinciding with the handgrip) to be pressed downwards while rotating it, is normally carried out as soon as the food contained in the receptacle is cooked, so that the handgrip is at a very high temperature, very close to the temperature of the metal part of the lid. The user is therefore obliged to use known protection means for the hands (normally kitchen gloves), which make the opening operation even more difficult. An object of the present invention is therefore to obviate the aforesaid drawbacks by providing the user with a lid of the stated type which is simple and decidedly more operable than known lids. Another drawback is due to the fact that for both technical and marketing reasons, the aforedescribed lids are provided with a thermometer which measures the temperature inside the cooking receptacle. This thermometer is positioned at the centre of the lid so that its extending part measures the temperature within a central area just below the lid, and hence in an optimal region within the cooking receptacle. The thermometer is preferably inserted into the handgrip and extends downwards to beyond the top of the support element. This creates a further complication in the manufacture of this type of known lid, as the combined handgrip-operating means has to be split into at least two concentric parts, one of which, the inner, is fixed to be able to receive the thermometer, while the other, the outer, is movable and represents the actual combined handgrip-operating means for operating the rotatable element.

Another object of the present invention is therefore to provide a lid which does not present this latter complication.

The aforestated objects are attained by a lid according to the present invention, characterised in that the movement of the rotatable element by the action of the operating means is independent of the handgrip, the rotatable element being free to move with respect to the handgrip.

The invention will be more apparent from the following description of two embodiments thereof. In this description reference is made to the accompanying drawings, in which:

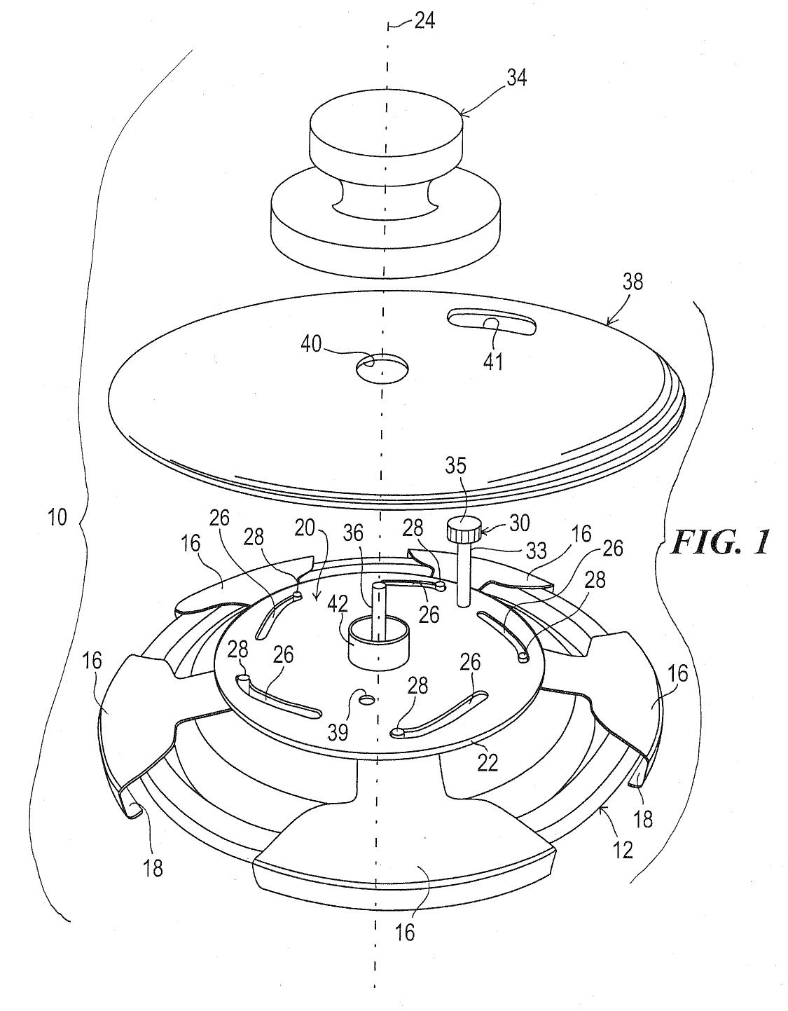

FIG. 1 is an exploded perspective view of a lid according to the present invention, with the jaws in their position of maximum withdrawal;

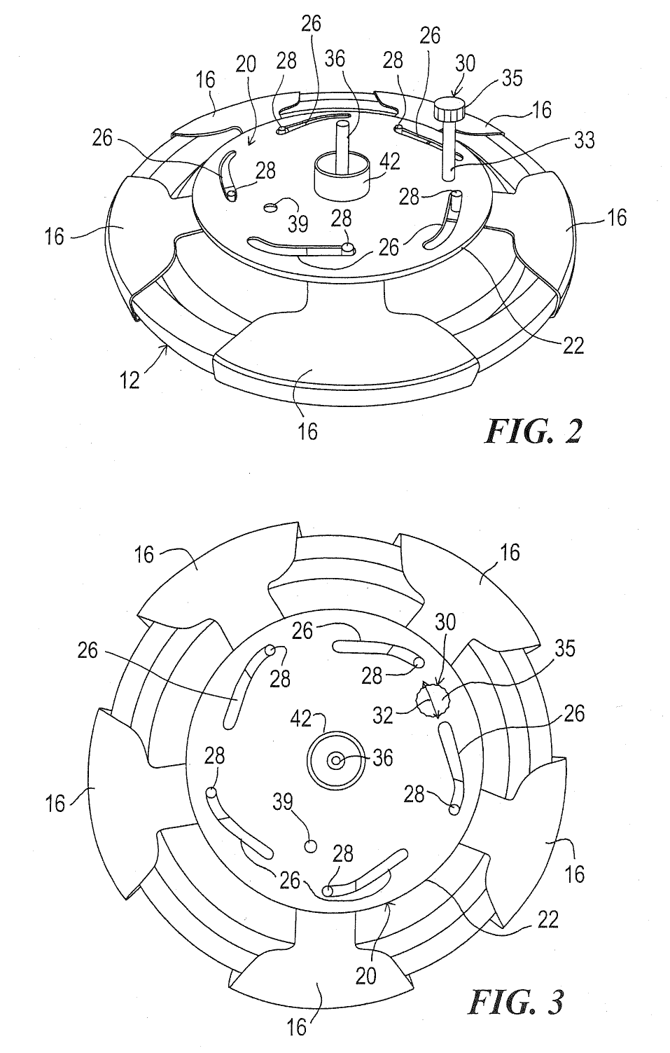

FIG. 2 is a perspective view of the lower part of FIG. 1, with the difference that the jaws are in their position of maximum approach;

FIG. 3 is a plan view of the same part, but with the jaws in the condition of FIG. 1;

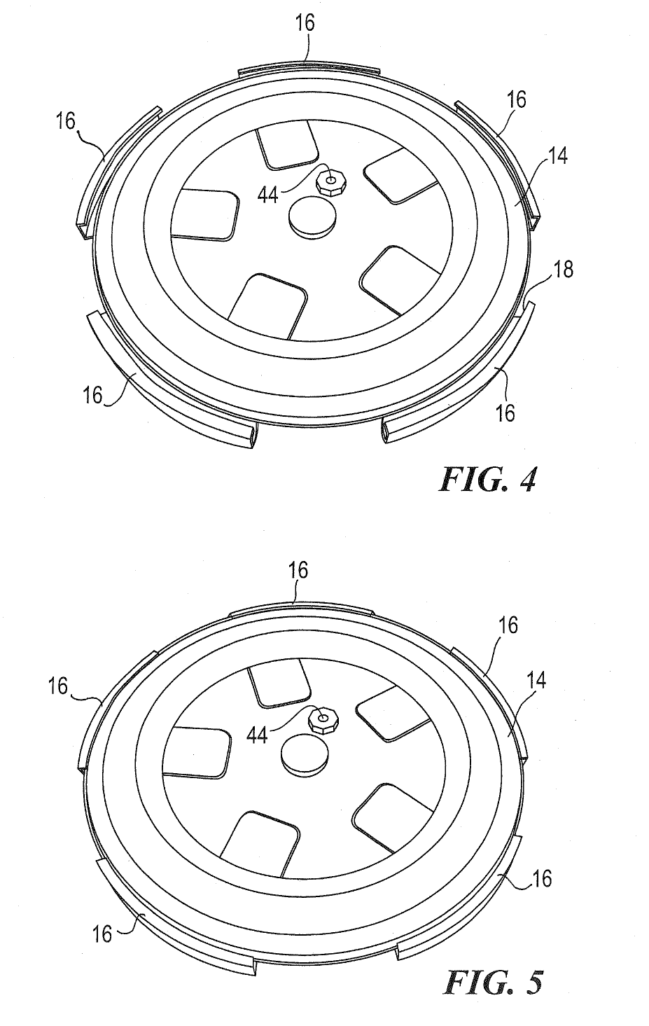

FIG. 4 is a perspective view showing the underlying face of the lower part of the lid, with the jaws in the condition of FIG. 1;

FIG. 5 is similar to FIG. 4, with the only difference that the jaws are in the condition of FIG. 2;

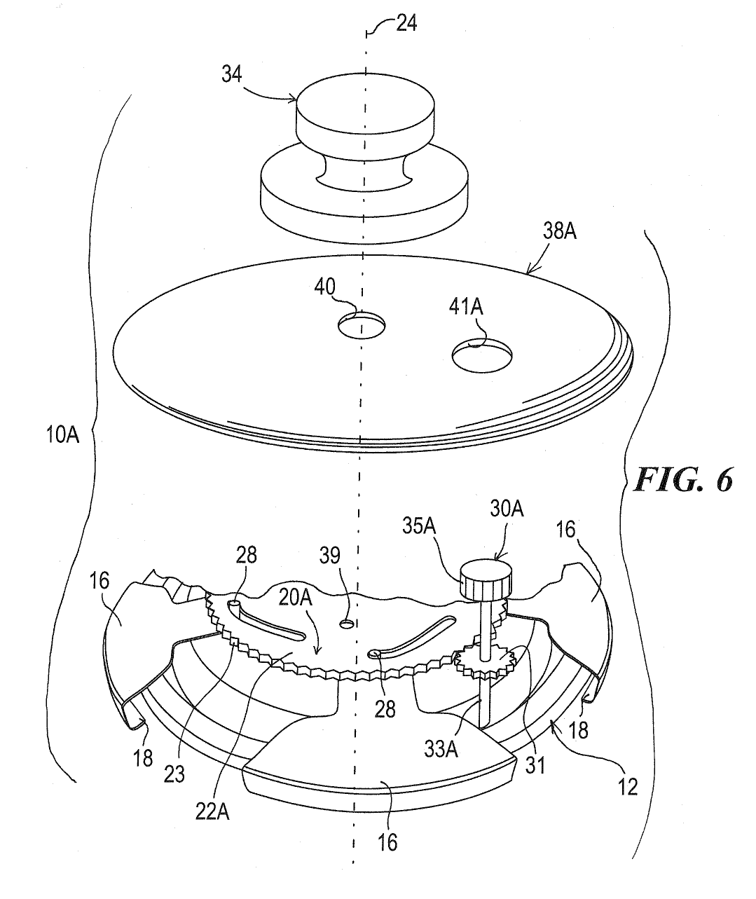

FIG. 6 is similar to FIG. 1 and shows a variant of the lid according to the present invention.

As can be seen from the figures, the lid 10 comprises a circular support element 12 which, in the manner of a lid, fits onto the outwardly extending upper edge of a cooking receptacle (not shown) by way of an interposed seal gasket 14 (FIGS. 4 and 5).

The support element 12 carries a multiplicity of jaws (five in the illustrated example), the hook-shaped end portions 18 (FIGS. 1 and 4) of which are intended to engage the outwardly extending upper edge of the cooking receptacle.

The support element 12 also carries a mechanism, indicated overall by 20, which enables the jaws 16 to be made to approach and respectively withdraw from the support element 12, in order to cause the end portions 18 of the jaws 16 to engage below the outwardly extending edge (not shown) of the cooking receptacle and respectively to disengage from said outwardly extending edge.

The control mechanism 20 comprises a disc-shaped element 22 rotatable about the axis 24 of the lid 10. In the illustrated example, the rotatable element 22 presents five slots 26 (their number being equal to that of the jaws 16) which constitute cam guides for receiving respective cam follower pins 28 extending upwards from the inner end of a relative jaw 16, this end being interposed between the support element 12 and the rotatable element 22.

Other known means different from the described slots 26 can be used for coupling the jaws 16 to the rotatable element 22.

For example the jaws 16 can be pivoted, directly or via small arms, possibly articulated, to the rotatable element 22. In all cases, the control mechanism 20 still comprises a rotatable element 22 and jaws 16 which can be coupled thereto.

The means for coupling the jaws 16 to the rotatable element 22 can be different from the aforedescribed, provided they are such that any possible movement of the rotatable element about its axis, in one direction or the other, results respectively in a centripetal movement or centrifugal movement of the jaws 16.

To operate the control mechanism 20 and hence cause the jaws 16 to withdraw or approach, an operating means is provided indicated overall by 30. This latter in the specific case of Figures from 1 to 3 comprises a pin 33 fixed to the rotatable element 22 and extending upwards. It is preferably provided with a knob 35 which the user can more easily grip with the fingers. This does not mean that the knob 35 is necessarily an added piece, the term “knob” also simply meaning the upper end of the pin 33.

As can be seen from Figures from 1 to 3, the knob 35 lies at a significant distance (arm) from the axis of rotation 24 of the rotatable element 22, so that to operate the mechanism it is sufficient to apply a very small tangential force to the knob 35 in one direction or another (depending on whether the jaws 16 are to be made to withdraw or approach), this force being indicated by the double arrow 32 in FIG. 3.

The lid 10 is also provided with a central handgrip 34 (FIG. 1) for its manipulation. In this specific example the handgrip 34 is fixed to the support element 12 by an externally threaded coaxial pin 36, the lower end of which is fixed to the support element 12. The pin 36 passes into a coaxial hole provided in the rotatable element 22 and projects above it, to enable the handgrip 34, provided for this purpose with a threaded coaxial hole (not shown) opening into the lower face of the handgrip 34, to be screwed onto it.

A conventional thermometer (not shown for simplicity) can be provided in the handgrip 34.

For aesthetic and hygienic reasons, and to prevent the mechanism 20 from becoming easily soiled (with consequent possible jamming), the lid 10 is provided (as are known lids of this type) with a cover 38 having a diameter just larger than that of the jaws when in their maximum withdrawal position. The cover 38 presents a central through hole 40 to allow passage of the threaded pin 36. The hole 40 has a diameter less than that of a bush 42 fixed coaxially to the rotatable element 22 such that the cover 38 can rest on the bush 42 and remain locked between this latte and the handgrip 34 when the handgrip is screwed onto the threaded pin 36. The cover 38 is provided with a slot-shaped through hole 41 through which the end part of the operating pin 33, which can also coincide with the knob 35, passes.

The considerable merit of the lid 10 is that because of the significant arm existing between the point at which the pin 33 is applied to the rotatable element 22 and the axis of rotation 24 of this latter, which coincides with the axis of the fixed central handgrip 34 (when completely screwed onto the pin 36), it becomes extremely easy, using one hand, namely the one gripping the handgrip 34, to prevent the support element 12 from rotating about the cooking receptacle without having to press hard on the handgrip 34, while with the other hand simultaneously rotating the rotatable element 22 by acting with the fingers of that other hand on the knob 35, so that the mechanism easily passes from the situation of FIG. 1 to that of FIG. 2 or vice versa.

In the variant shown in FIG. 6, the lid 10A differs from the lid 10 of FIGS. 1-3 by a different means of operating the control mechanism 20A. In this respect, the circular rotatable element 22A has a toothed peripheral edge (23) which engages a pinion 31 keyed onto a vertical spindle 33A, the lower end of which is rotatably fixed to the support element 12. On the top of the spindle 33A a knurled knob 35A is fixed, which can be operated with the fingers to rotate the spindle 33A and hence the pinion 31 keyed onto this latter. The pinion 31 then rotates the rotatable element 22, to hence operate the mechanism 20A, of which the remainder is identical to the mechanism 20 of FIGS. 1-3 (so that no further description is necessary). Instead of being keyed onto the spindle 33A, both the pinion 31 and the knurled knob 35A could form an integral part of its structure.

The lid 10A is also provided with a cover 38A which differs from the cover 38 of FIG. 1 only in that instead of the slotted hole 41, a circular hole 41A is provided through which the operating knob 35 can pass.

It should also be noted that the lid of the invention must be provided with conventional safety valves, which have not been shown in the figures in order not to complicate them further and also because these valves do not form part of the present invention.

The lid can also be provided with a safety device to prevent the control mechanism (20, 20A) from being able to be operated when the cooking receptacle is under pressure. In this specific example the safety device comprises a piston 44 (FIGS. 4 and 5) which projects upwards from the support element 12 when the cooking receptacle is under pressure, the piston 44 when in this condition becoming inserted in hole 39 provided in the rotatable element 22, to prevent it from rotating.

1. A pressure cooker lid, comprising:
a support element which, in the manner of a lid, fits onto an outwardly extending upper edge of a cooking receptacle by way of an interposed seal gasket;
a plurality of movable jaws carried by the support element, the end portions of the jaws being intended to engage the outwardly extending upper edge of the cooking receptacle;
a mechanism comprising an element rotatable about an axis of the support element, the mechanism enabling the jaws to be made to approach or respectively withdraw from the support element by rotating the rotatable element in one direction or the other, to cause the end portions of the jaws to engage the outwardly extending edge of the cooking receptacle and respectively to disengage said end portions from said edge;
a handgrip, connected directly or indirectly to the support element, for manipulating the lid;
an operating means for rotating the rotatable element of the control mechanism, comprising a knob enabling the user to operate the operating means;
wherein:
movement of the rotatable element by the action of the operating means is independent of the handgrip, the rotatable element being free to move with respect to the handgrip,
the operating means comprises an operating pin carrying the knob, the operating pin extending upwards, it being fixed eccentrically to the rotatable element and being eccentric to an axis of rotation of the rotatable element.

2. A lid as claimed in claim 1, wherein the manipulating means comprises a pin carrying the knob, a lower end of the pin being rotatably fixed to the support element, wherein a pin outer surface, a knob outer surface, or both the pin outer surface and the knob outer surface present an entire or partial pinion structure which engages a toothing provided on a circular peripheral edge of the rotatable element.

3. A lid as claimed in claim 1, wherein a cover upperly covering the support element, the jaws and the control mechanism is provided, the cover comprising a first through hole coaxial with the support element, through which means for fixing the handgrip to the support element pass, and at least a second slotted through hole through which the knob can project to the outside, whether the jaws are in their condition of withdrawal or approach.

4. A lid as claimed in claim 1, wherein a cover upperly covering the support element, the jaws and the control mechanism is provided, the cover comprising a first through hole coaxial with the support element, through which means for fixing the handgrip to the support element, pass and at least a second through hole through which the knob projects to the outside.

5. A lid as claimed in claim 1, wherein a thermometer is incorporated into the handgrip to measure temperature in the interior of the cooking receptacle.

6. A lid as claimed in claim 1, comprising a safety device preventing rotation of the rotatable element when the cooking receptacle is under pressure, the safety device comprising, carried by the support element, a vertically movable piston which when the cooking receptacle is under pressure is thrust upwards to enter a hole provided in the rotatable element in order to prevent its rotation.
